(19) United States
(12) Patent Application Publication
(10) Pub. No.: US 2016/0232353 A1
(43) Pub. Date: Aug. 11, 2016

(54) Determining Model Protection Level On-Device based on Malware Detection in Similar Devices

(71) Applicant: QUALCOMM Incorporated, San Diego, CA (US)

(72) Inventors: Rajarshi Gupta, Sunnyvale, CA (US); Bjorn Marcus Jakobsson, Portola Valley, CA (US); Vinay Sridhara, Santa Clara, CA (US)

(21) Appl. No.: 14/616,794

(22) Filed: Feb. 9, 2015

(51) Int. Cl. G06F 21/56

(52) U.S. Cl. CPC G06F 21/566; G06F 21/564

(57) ABSTRACT

Methods, systems and devices for identifying, classifying, modeling, and responding to mobile device behaviors may include using lightweight processes to monitor and analyze various conditions and device behaviors to detect an instance of a non-benign behavior, increasing a level of security or scrutiny to identify other instances of non-benign behavior, and notifying select computing devices of the increased security risk so that they may also increase their security/scrutiny levels. For example, a computing device may be configured to perform a first type of analysis operations (e.g., lightweight analysis operations) to determine whether there is an increased security risk, and perform a second type of analysis operations (e.g., robust analysis operations) in response to determining that there is an increased security risk to determine whether there are additional security risks that are different from the security risk detected via the performance of the first type of analysis operations.

### BACKGROUND

Cellular and wireless communication technologies have seen explosive growth over the past several years. This growth has been fueled by better communications, hardware, larger networks, and more reliable protocols. Wireless service providers are now able to offer their customers an ever-expanding array of features and services, and provide users with unprecedented levels of access to information, resources, and communications. To keep pace with these service enhancements, mobile electronic devices (e.g., cellular phones, tablets, laptops, etc.) have become more powerful and complex than ever. This complexity has created new opportunities for malicious software, software conflicts, hardware faults, and other similar errors or phenomena to negatively impact a mobile device's long-term and continued performance and power utilization levels. Accordingly, identifying and correcting the conditions and/or mobile device behaviors that may negatively impact the mobile device's long term and continued performance and power utilization levels is beneficial to consumers.

### SUMMARY

The various embodiments include methods of analyzing behaviors in a computing device, including performing in a processor of the computing device a first type of analysis operations to determine whether there is an increased security risk, the first type of analysis operations including monitoring the computing device for an indication of the increased security risk or a previous occurrence of risk, and performing a second type of analysis operations in response to determining that there is the increased security risk, in which the second type of analysis operations are more computationally-intensive than the first type of analysis operations.

In an embodiment, performing the first type of analysis operations may include performing lightweight analysis operations, and performing the second type of analysis operations may include performing robust analysis operations. In a further embodiment, performing robust analysis operations may include identifying another security risk that is different than the increased security risk detected via the lightweight analysis operations. In a further embodiment, monitoring the computing device for the indication of the increased security risk or the previous occurrence of risk may include monitoring the computing device for a notification message from another computing device indicating the increased security risk.

In a further embodiment, monitoring the computing device for the indication of the increased security risk or the previous occurrence of risk may include monitoring one or more of an internal computation, a file, a functional behavior, and a data access request. In a further embodiment, monitoring the computing device for the indication of the increased security risk or the previous occurrence of risk may include monitoring the computing device to identify a data pattern associated with non-benign actions. In a further embodiment, monitoring the computing device for the indication of the increased security risk or the previous occurrence of risk may include monitoring the computing device for common consequences of malware infection. In a further embodiment, monitoring the computing device for common consequences of malware infection may include performing one of monitoring a number of premium SMS message sent in a period of time, monitoring increases in traffic to sites associated with malicious behavior, monitoring a number of address book contacts communicated in the period of time, monitoring a number of password modifications in the period of time, and monitoring changes to device configuration.

In a further embodiment, the method may include generating a notification message that includes risk information in response to determining that there is the increased security risk, and sending the notification message to one or more computing devices. In a further embodiment, the method may include receiving a notification message from another computing device that includes risk information, and determining that there is the increased security risk based on the risk information included in the received notification message. In a further embodiment, determining that there is the increased security risk based on the risk information included in the received notification message may include determining that there is the increased security risk based at least in part on a distance between the another computing device sending the received notification message, in which the distance includes one or more of a physical distance, a time difference between a detected security risk and the received notification message, a network separation distance, a number of times the computing device has been rebooted, a number of times a software application has been updated, differences between software versions, and make, model, version, feature, or hardware differences between the transmitting and receiving computing devices.

In a further embodiment, performing lightweight analysis operations may include monitoring device behaviors to collect behavior information, generating a behavior vector data structure based on the collected behavior information, applying the behavior vector data structure to a lean classifier model to obtain a determination of whether a first device behavior is non-benign, and determining that there is the increased security risk in response to determining that the first device behavior is non-benign. In a further embodiment, performing robust analysis operations may include performing a full scan of the computing device.

In a further embodiment, performing robust analysis operations may include applying a behavior vector data structure to a full classifier model to obtain a determination of whether another security risk is present in the computing device. In a further embodiment, performing robust analysis operations may include monitoring additional device behaviors to collect additional behavior information, generating a plurality of behavior vector data structures based on the collected additional behavior information, and applying each of the plurality of behavior vector data structures to a classifier model. In a further embodiment, performing robust analysis operations in response to determining that there is the increased security risk may include performing robust analysis operations for a dynamically determined time period. In a further embodiment, the method may include dynamically determining the time period based on a distance between the computing device and a second computing device.

Further embodiments may include a computing device having various means (e.g., processor, memory, etc.) for performing functions corresponding to the method operations discussed above, including means for performing a first type of analysis operations to determine whether there is an increased security risk, the first type of analysis operations including monitoring the computing device for an indication of the increased security risk or a previous occurrence of risk, and means for performing a second type of analysis operations in response to determining that there is the increased security risk, in which the second type of analysis operations are more computationally-intensive than the first type of analysis operations. In an embodiment, the means for performing the first type of analysis operations may include means for performing lightweight analysis operations, and means for performing the second type of analysis operations may include means for performing robust analysis operations. In a further embodiment, the means for performing robust analysis operations may include means for identifying another security risk that is different than the increased security risk detected via lightweight analysis operations.

Further embodiments may include a computing device having a processor configured with processor-executable software instructions to perform operations that include performing a first type of analysis operations to determine whether there is an increased security risk, the first type of analysis operations including monitoring the computing device for an indication of the increased security risk or a previous occurrence of risk, and performing a second type of analysis operations in response to determining that there is the increased security risk, in which the second type of analysis operations are more computationally-intensive than the first type of analysis operations.

In an embodiment, the processor may be configured with processor-executable software instructions to perform operations such that performing the first type of analysis operations includes performing lightweight analysis operations, and performing the second type of analysis operations includes performing robust analysis operations. In a further embodiment, the processor may be configured with processor-executable software instructions to perform operations such that performing robust analysis operations includes identifying another security risk that is different than the increased security risk detected via lightweight analysis operations. In a further embodiment, the processor may be configured with processor-executable software instructions to perform operations such that performing lightweight analysis operations includes monitoring device behaviors to collect behavior information, generating a behavior vector data structure based on the collected behavior information, applying the behavior vector data structure to a lean classifier model to obtain a determination of whether a first device behavior is non-benign, and determining that there is the increased security risk in response to determining that the first device behavior is non-benign.

In a further embodiment, the processor may be configured with processor-executable software instructions to perform operations such that performing robust analysis operations includes monitoring additional device behaviors to collect additional behavior information, generating a plurality of behavior vector data structures based on the collected additional behavior information, and applying each of the plurality of behavior vector data structures to a classifier model. In a further embodiment, the processor may be configured with processor-executable software instructions to perform operations that further include receiving a notification message from another computing device that includes risk information, and determining that there is the increased security risk based on the risk information included in the received notification message and a distance between the computing device and the another computing device sending the received notification message.

Further embodiments may include a non-transitory computer readable storage medium having stored thereon processor-executable software instructions configured to cause a processor of a computing device to perform operations including performing a first type of analysis operations to determine whether there is an increased security risk, the first type of analysis operations including monitoring the computing device for an indication of the increased security risk or a previous occurrence of risk, and performing a second type of analysis operations in response to determining that there is the increased security risk, in which the second type of analysis operations are more computationally-intensive than the first type of analysis operations.

In an embodiment, the stored processor-executable software instructions may be configured to cause a processor to perform operations such that performing the first type of analysis operations includes performing lightweight analysis operations, and performing the second type of analysis operations includes performing robust analysis operations. In a further embodiment, the stored processor-executable software instructions may be configured to cause a processor to perform operations such that performing robust analysis operations includes identifying another security risk that is different than the increased security risk detected via lightweight analysis operations. In a further embodiment, the stored processor-executable software instructions may be configured to cause a processor to perform operations that further include receiving a notification message from another computing device that includes risk information, and determining that there is the increased security risk based on the risk information included in the received notification message and a distance to the another computing device sending the received notification message.

Further embodiments may include a computing device having a processor configured with processor-executable instructions to perform various operations corresponding to the methods discussed above. Further embodiments may include a computing device having various means for performing functions corresponding to the method operations discussed above. Further embodiments may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating network components of an example telecommunication system suitable for use in the various embodiments.

FIG. 2 is a block diagram illustrating example logical components and information flows in an embodiment mobile device configured to determine whether a particular mobile device behavior, software application, or process is performance-degrading, suspicious, or benign.

FIG. 3 is a process flow diagram illustrating a method of performing analyzing behaviors in a computing device in accordance with an embodiment.

FIG. 4 is a process flow diagram illustrating another embodiment mobile device method of generating lean classifier models in the mobile device.

FIG. 5 is an illustration of example decision nodes that may be generated and used to generate lean classifier models in accordance with an embodiment.

FIG. 6 is a process flow diagram illustrating a method for performing adaptive observations in a computing device in accordance with an embodiment.

FIG. 7 is a component block diagram of a mobile device suitable for use in an embodiment.

FIG. 8 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

In overview, the various embodiments include methods, and computing devices configured to implement the methods, of efficiently identifying, classifying, modeling, preventing, and/or correcting the conditions and behaviors that often degrade a computing device's performance, power utilization levels, network usage levels, security and/or privacy over time. A computing device may be configured to perform a first type of analysis operations (e.g., lightweight analysis operations) to determine whether there is an increased security risk, and perform a second type of analysis operations (e.g., robust analysis operations) in response to determining that there is an increased security risk so as to determine whether there are additional security risks that are different from the security risk detected via the performance of the first type of analysis operations.

It has been observed that when a computing device has been compromised by one instance of non-benign behavior (e.g., malfunctioning memory, malware, unauthorized access, etc.), other instances of non-benign behavior may be present, and the computing device may be vulnerable to other forms of malware and attack by unauthorized parties, such as enabled by the non-benign behavior or informed of the computing device's vulnerabilities. It has also been observed that when a device is affected by malware, it is more likely to download or execute other types of malware and/or attempt to infect other computing devices with the malware. In view of these observations, a computing device may be configured to perform a first type of analysis operations using lightweight processes to monitor and analyze various conditions and device behaviors to detect an instance of a non-benign activity, behavior, operation, action, condition, event, application, or process (collectively “behavior”) in that computing device. The computing device may increase its level of security or scrutiny performing a second type of analysis operations to be on alert for other instances of non-benign behavior in response to detecting one instance of a non-benign behavior.

Increasing the level of security or scrutiny may involve running a heavyweight or computationally-intensive behavior analysis and scanning engine, using a signature-based detection technique, collecting more detailed behavior information in the computing device, using a more robust classifier model to perform heightened analysis of observed device behaviors, etc. For instance, increasing the level of security/scrutiny may include performing at least one test to determine whether the device has a rootkit, performing at least one test to determine whether the device has a Trojan, performing at least one test to determine whether the device has undesirable software, and reviewing the history of events associated with the device to determine whether there is an indication of an undesirable event, the updating of a software, or the generation of an alert message. In an embodiment, the computing device may be configured to notify select computing devices of the increased security risk in response to identifying an instance of a non-benign behavior. In an embodiment, the computing device may be configured to increase its security/scrutiny levels in response to receiving a notification of an increased security risk from another computing device.

In an embodiment, the computing device may be equipped with a communication module, a behavior-based security module, a risk detection module, a scan module, and an actuator module. The communication module may be configured to send and receive security risk information to and from select other computing devices, such as other computing devices that are in close proximity to the device, share resources with the computing device, that are similarly equipped as the computing device, etc. The risk detection module may be configured to perform a first type of analysis operations, which may include using risk information received from other computing devices and/or analysis information generated by the behavior-based security module of the device to determine whether there is an increased security risk. In response to determining that there is an increased security risk, the scan module may perform a second type of analysis operations, which may include performing heightened analysis operations (e.g., by running a computationally-intensive full scan process, collecting more information, using more robust classifier models, etc.) to identify other instances of non-benign behavior in the device. A full scan may include using conventional malware scanning techniques to analyze a large number of files to identify other instances of non-benign behaviors. If other instances of non-benign behaviors are detected in that computing device, the computing device may inform the other devices of the increased security risk, and cause the actuator module to perform various security operations to correct, mitigate, or otherwise respond to a cause or source of the identified non-benign behavior in that device.

In an embodiment, the computing device may be configured to perform lightweight analysis operations that include using a lean classifier model to evaluate select processes operating on the device until a single instance of a non-benign behavior is detected. The computing device may switch to a full classifier model and evaluate all the processes operating on the device in response to detecting an instance of a non-benign behavior. The computing device may stay in this heightened analysis mode (and thus continue to perform more robust analysis operations) for a static or dynamically determined period of time. The computing device may also inform other similar computing devices (e.g., via a network server in the cloud, etc.) of the detected instances of non-benign behaviors so as to cause those devices to enter a heightened analysis mode. The computing device or network server may identify the “similar” computing devices that are to be informed of a detected instance of a non-benign behavior based on a variety of factors, such as whether the devices are equipped with a behavior-based security system, include the same version of an operating system, have downloaded the same software application, have a similar role (e.g., devices being used by the military in Iraq, etc.), subscribe to a premium service, etc.

In an embodiment, the computing device may be configured to perform lightweight analysis operations (e.g., a first type of analysis operations) that include using lightweight processes and/or a lean classifier model to continuously or repeatedly evaluate select device behaviors, use the results of these evaluations to update the value of a risk parameter, and switch to performing robust analysis operations (e.g., a second type of analysis operations) that include using heavyweight processes and/or full classifier models to evaluate a larger number of device behaviors for a period of time when the value of the risk parameter exceeds a threshold value. In various embodiments, the computing device may be configured to determine the risk parameter value, threshold value, and/or time period based on a “distance.” This distance may be a physical distance between the current device and the device that detected an instance of non-benign behavior (i.e., the affected device). Alternatively or in addition, the distance may be an amount of time that has elapsed since an instance of non-benign behavior was detected, the number of times the computing device has been rebooted, the number of times a software application has been updated, differences between software versions, make/model/version/feature/hardware differences between the transmitting and receiving computing devices, etc. The distance may also be a network distance that identifies the number of intermediate nodes or components that are between the current device and the affected device, or a logical distance that identifies the similarities in configuration, use, role, services used, etc. between the current device and the affected device.

Thus, the various embodiments allow the computing device to perform lightweight analysis operations (e.g., a first type of analysis operations) that include using a lightweight and low-power process to repeatedly or continuously monitor the device for risks, and perform more robust scanning, monitoring, and analysis operations (e.g., a second type of analysis operations) when there is a heightened security risk. This improves the functioning of the computing device by improving its performance and power consumption characteristics. Further, by sharing the risk information with other computing devices, each computing device may identify and react to performance-limiting and undesirable operating conditions much faster and with lower power consumption than if the heightened analysis were performed in each device. This further improves the functioning of the computing device.

Additional improvements to the functions, functionalities, and/or functioning of computing devices will be evident from the detailed descriptions of the embodiments provided below.

The terms “mobile computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor for which performance is important, and operate under battery power such that power conservation methods are of benefit. While the various embodiments are particularly useful for mobile computing devices, such as smartphones, which have limited resources and run on battery, the embodiments are generally useful in any electronic device that includes a processor and executes application programs.

The term “performance degradation” is used in this application to refer to a wide variety of undesirable operations and characteristics of a computing device, such as longer processing times, slower real time responsiveness, lower battery life, loss of private data, malicious economic activity (e.g., sending unauthorized premium SMS message), denial of service (DoS), poorly written or designed software applications, malicious software, malware, viruses, fragmented memory, operations relating to commandeering the computing device or utilizing the device for spying or botnet activities, etc. Also, behaviors, activities, and conditions that degrade performance for any of these reasons are referred to herein as “not benign” or “non-benign.”

Generally, the performance and power efficiency of a mobile device degrade over time. Recently, anti-virus companies (e.g., McAfee, Symantec, etc.) have begun marketing mobile anti-virus, firewall, and encryption products that aim to slow this degradation. However, many of these solutions rely on the periodic execution of a computationally intensive scanning engine (or performing a full scan) on the mobile device, which may consume many of the mobile device's processing and battery resources, slow or render the mobile device useless for extended periods of time, and/or otherwise degrade the user experience. In addition, these solutions are typically limited to detecting known viruses and malware, and do not address the multiple complex factors and/or the interactions that often combine to contribute to a mobile device's degradation over time (e.g., when the performance degradation is not caused by viruses or malware). For these and other reasons, existing anti-virus, firewall, and encryption products do not provide adequate solutions for identifying the numerous factors that may contribute to a mobile device's degradation over time, for preventing mobile device degradation, or for efficiently restoring an aging mobile device to its original condition.

Mobile devices are resource constrained systems that have relatively limited processing, memory, and energy resources. Modern mobile devices are also complex systems, and there are a large variety of factors that may contribute to the degradation in performance and power utilization levels of a mobile device over time, including poorly designed software applications, malware, viruses, fragmented memory, background processes, etc. Due to the number, variety, and complexity of these factors, it is often not feasible to evaluate all the factors that may contribute to the degradation in performance and/or power utilization levels of the complex yet resource-constrained systems of modern mobile devices.

To overcome the limitations of existing solutions, the various embodiments include computing devices equipped with a behavioral monitoring and analysis system configured to quickly and efficiently identify non-benign software applications (e.g., applications that are malicious, poorly written, incompatible with the device, etc.), and prevent such applications from degrading the a computing device's performance, power utilization levels, network usage levels, security, and/or privacy over time. The behavioral monitoring and analysis system may be configured to identify, prevent, and correct identified problems without having a significant, negative, or user perceivable impact on the responsiveness, performance, or power consumption characteristics of the computing device.

To further improve performance, the computing device may be configured to work in conjunction with other computing devices to intelligently and efficiently determine whether they are susceptible to non-benign behaviors, such as malware, cyber attacks, malfunctioning software, etc. Each of a plurality of computing devices may be configured to perform lightweight security operations (e.g., behavior-based observation and analysis operations, etc.) to identify software applications or processes that have a high potential to contribute to the computing device's degradation over time. Such behavior-based operations may include an observer process, daemon, module, or sub-system (herein collectively referred to as a “module”) instrumenting or coordinating various application programming interfaces (APIs) at various levels of the computing device system, and collecting behavior information from the instrumented APIs.

The observer module may communicate (e.g., via a memory write operation, function call, etc.) the collected behavior information to a behavior extractor module (e.g., via a memory write operation, etc.) of the computing device, which may use the behavior information (i.e., the information collected by the observer module) to generate behavior vectors that represent or characterize a device behavior. Each behavior vector may be an information structure that includes or encapsulates one or more “behavior features.” A behavior feature may be an abstract number or symbol that represents all or a portion of an observed event, condition, activity, operation, relationship, interaction, or behavior in the computing device. Each behavior feature may be associated with a data type that identifies a range of possible values, operations that may be performed on those values, the meanings of the values, and other similar information. The data type may be used by the computing device to determine how the corresponding behavior feature (or feature value) should be measured, analyzed, weighted, or used.

The behavior extractor module may communicate (e.g., via a memory write operation, function call, etc.) the generated behavior vectors to the analyzer module, which may apply the behavior vectors to classifier models to determine whether the device behavior of an application is non-benign. A classifier model may be a behavior model that includes data, entries, decision nodes, decision criteria, and/or information structures that may be used by a device processor to quickly and efficiently test or evaluate specific features, factors, data points, entries, APIs, states, conditions, behaviors, software applications, processes, operations, components, etc. (herein collectively “features”) or other embodiments of the device's behavior. A classifier model may also include information that may be used by a device processor to determine the nature of the relationships between software applications and/or the behaviors that to be monitored in the computing device.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular computing device behavior is not benign. A local classifier model may be a lean classifier model that is generated in the computing device. A device-specific classifier model may be a local classifier model that includes a focused data model that includes/tests only computing device-specific features/entries that are determined to be most relevant to classifying an activity or behavior in that specific device. An application-specific classifier model may be a local classifier model that includes a focused data model that includes or prioritizes tests on the features/entries that are most relevant for determining whether a particular software application (or a specific type of software application) is non-benign.

Thus, the analyzer module may apply behavior vectors to classifier models to determine whether a particular computing device behavior, software application, or process is non-benign. The device processor may then perform various operations to correct, heal, cure, isolate, or otherwise fix the identified problems (e.g., behaviors determined to be non-benign). The device processor may also increase its security/scrutiny levels to identify other instances of non-benign behaviors in that device, and notify the other computing devices of the increased security risk.

In an embodiment, the computing devices may be configured to increase their respective security/scrutiny levels for a time period or duration after identifying an instance of non-benign behavior or receiving risk information from another device, and return to normal monitoring and analysis operations after the first time period/duration. A computing device may be configured to use a lean classifier model to evaluate device behaviors until a first instance of a non-benign behavior is identified, commence using a full classifier model for the first time period/duration after the first instance of a non-benign behavior is identified, and revert back to using a lean classifier model after the first time period/duration if no additional instances of non-benign behavior are identified. This time period/duration may be a fixed duration or determined dynamically based on metrics, such as the number of behavior vectors that were previously classified as benign, a confidence level of detected malware, the criticality or severity of the detected non-benign behavior, etc.

In an embodiment, the time period/duration for the heightened security/scrutiny may be determined dynamically so that it is inversely proportional to distance from original affected device. This distance may be a physical distance between the current device and the device that detected an instance of non-benign behavior (i.e., the affected device). The distance may also or alternatively be a network distance that identifies the number of intermediate nodes or components that are between the current device and the affected device, or a logical distance that identifies the similarities in configuration, use, role, services used, etc. between the current device and the affected device.

In an embodiment, computing devices may be configured to establish or join a trust network that includes a plurality of pre-screened or trusted computing devices. In various embodiments, establishing or joining a trust network may include each computing device performing group formation operations that include establishing communication links to the other computing devices another via peer-to-peer, WiFi-Direct, or other similar technologies. Computing devices may also be connected via a shared secure network, enterprise virtual private network, and other similar technologies or group classifications. In an embodiment, a trusted network may include computing devices that are the same network or which have direct communication links. Each computing device in the trusted network may be configured to perform collaborative learning operations that include sharing risk information, behavior vectors, classifier models, the results of the analysis operations, and other similar information with other computing devices in the trusted network.

In an embodiment, the computing devices configured to work in conjunction with a server to more efficiently identify, classify, model, prevent, and/or correct the conditions and/or behaviors that often degrade performance and/or power utilization levels over time. The server, which may be a server in a communication network or a server accessible via the Internet, may be configured to receive information on various risk levels, capabilities, states, conditions, features, behaviors and corrective actions from a central database (e.g., the “cloud”) and/or from many computing devices, and use this information to generate a full classifier model (i.e., a data or behavior model) that describes a large corpus of behavior information in a format or structure (e.g., finite state machine, etc.) that can be quickly converted into one or more lean classifier models.

In an embodiment, the full classifier model may be a finite state machine description or representation of the large corpus of behavior information. In an embodiment, the finite state machine may include information that is suitable for expression as a plurality of nodes, boosted decision trees, or decision stumps that each test one or more features. For example, the finite state machine may be an information structure that may be expressed as a family of boosted decision stumps that collectively identify, describe, test, or evaluate all or many of the features and data points that are relevant to determining whether a computing device behavior is benign or contributing to that computing device's degradation in performance over time. The server may then send the full or lean classifier models (i.e., information structures that include the finite state machine and/or family of boosted decision stumps, etc.) to the computing device.

The computing device may be configured to receive and use these classifier models to identify, prevent, and/or correct the conditions, factors, and/or computing device behaviors that contribute to degrading the performance and/or power utilization levels of the computing device over time. The computing device may also use the classifier models to generate even leaner classifier models locally in the computing device. To accomplish this, the computing device may prune or cull the robust family of boosted decision trees included in the classifier model received from the server to generate a leaner classifier model that includes a reduced number of boosted decision trees and/or evaluates a limited number of test conditions or features. The computing device may then use this classifier models to perform real-time behavior monitoring and analysis operations and identify a source or a cause of an undesirable or performance degrading computing device behavior.

The computing device processor may be configured to perform lightweight analysis operations to determine whether there is an increased security risk, and perform robust analysis operations in response to determining that there is an increased security risk. The lightweight analysis operations may include monitoring the device for an indication of the increased security risk or a previous occurrence of risk. In an embodiment, this may be accomplished by monitoring the device for a notification message from another computing device. For example, the computing device may be configured to apply behavior vector information structures to lean classifier models, use lightweight processes to monitor and analyze various conditions and device behaviors, and monitor a port for notification messages that include risk information. The computing device may perform robust analysis operations in response to receiving a notification message that include risk information indicating an elevated risk (e.g., another device within the vicinity of the computing device has been infected with a virus).

In some embodiments, the computing device processor may be configured to perform lightweight analysis operations that include identifying indications of increased security risks/threats by monitoring an internal computation, a file, a functional behavior, a data access request, etc., monitoring the device to identify a data pattern associated with non-benign actions, monitoring the device for common consequences of malware infection, and/or performing other similar operations. To identify common consequences of malware, the computing device may monitor the number of premium SMS message sent in a period of time, monitor increases in traffic to sites associated with malicious activity/behavior, monitor the number of address book contacts communicated in a period of time, monitor the number of times a password has been modified in a period of time, monitor the changes to the computing device's configuration (e.g., the number of changes, the frequency of changes, the significance/extent of the changes, etc.), and/or performing other similar operations.

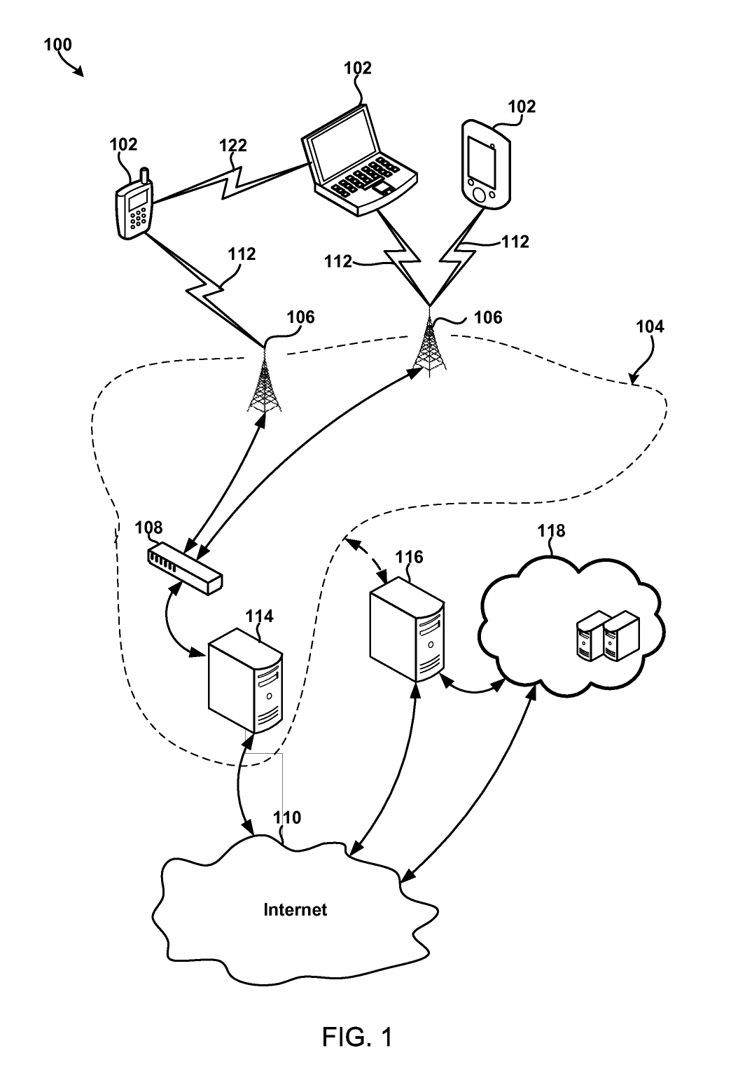

The various embodiments may be implemented within a variety of communication systems, such as the example communication system 100 illustrated in FIG. 1. A typical cell telephone network 104 includes a plurality of cell base stations 106 coupled to a network operations center 108, which operates to connect voice calls and data between mobile devices 102 (e.g., cell phones, laptops, tablets, etc.) and other network destinations, such as via telephone land lines (e.g., a POTS network, not shown) and the Internet 110. Communications between the mobile devices 102 and the telephone network 104 may be accomplished via two-way wireless communication links 112, such as 4G, 3G, CDMA, TDMA, LTE and/or other cell telephone communication technologies. The telephone network 104 may also include one or more servers 114 coupled to or within the network operations center 108 that provide a connection to the Internet 110.

Each mobile device 102 may be configured to share risk information, behavior vectors, data/behavior models, the results of real-time behavior analysis operations, success rates, and other similar information with other mobile devices 102 in the system 100. Communications between the mobile devices 102 may be accomplished through direct or peer-to-peer communication links 122, telephone network 104, or via the Internet 110.

The communication system 100 may further include network servers 116 connected to the telephone network 104 and to the Internet 110. The connection between the network server 116 and the telephone network 104 may be through the Internet 110 or through a private network (as illustrated by the dashed arrows). The network server 116 may also be implemented as a server within the network infrastructure of a cloud service provider network 118. Communication between the network server 116 and the mobile devices 102 may be achieved through the telephone network 104, the internet 110, private network (not illustrated), or any combination thereof.

In an embodiment, the network server 116 may be configured to send data/behavior models to the mobile device 102, which may receive and use the data/behavior models to identify suspicious or performance-degrading mobile device behaviors, software applications, processes, etc. The network server 116 may also send classification and modeling information to the mobile devices 102 to replace, update, create and/or maintain mobile device data/behavior models.

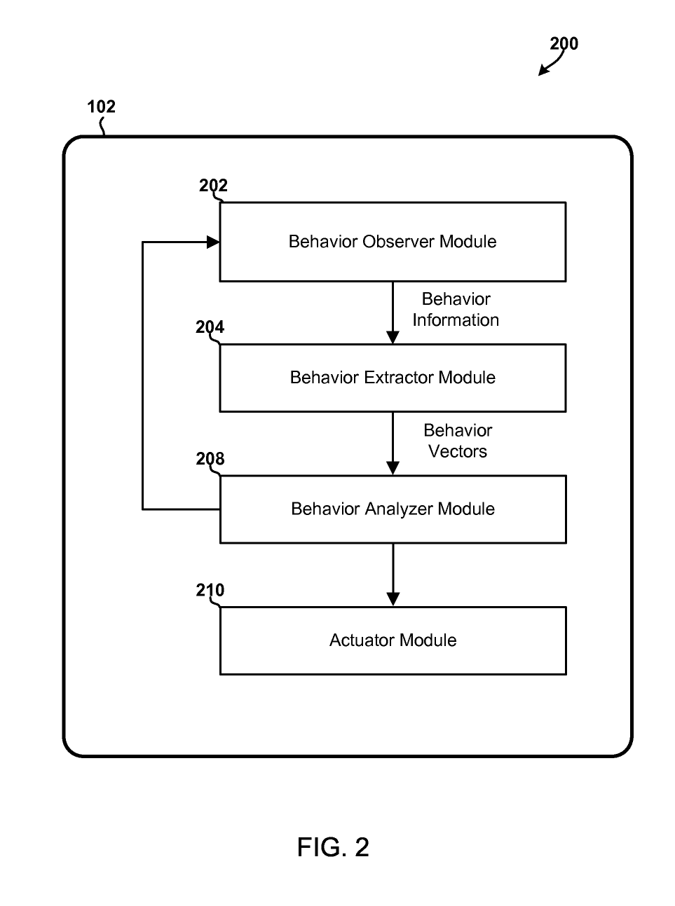

FIG. 2 illustrates example logical components and information flows in an embodiment mobile computing device 102 that includes a behavior-based security system 200 configured to use behavioral analysis techniques to identify and respond to non-benign device behaviors. In the example illustrated in FIG. 2, the computing device is a mobile computing device 102 that includes a device processor (i.e., mobile device processor) configured with executable instruction modules that include a behavior observer module 202, a behavior extractor module 204, a behavior analyzer module 208, and an actuator module 210. Each of the modules 202-210 may be a thread, process, daemon, module, sub-system, or component that is implemented in software, hardware, or a combination thereof. In various embodiments, the modules 202-210 may be implemented within parts of the operating system (e.g., within the kernel, in the kernel space, in the user space, etc.), within separate programs or applications, in specialized hardware buffers or processors, or any combination thereof. In an embodiment, one or more of the modules 202-210 may be implemented as software instructions executing on one or more processors or processing cores of the mobile computing device 102.

The behavior observer module 202 may be configured to instrument application programming interfaces (APIs), counters, hardware monitors, etc. at various levels/modules of the device, and monitor the activities, conditions, operations, and events (e.g., system events, state changes, etc.) at the various levels/modules over a period of time. For example, the behavior observer module 202 may be configured to monitor various software and hardware components of the mobile computing device 102, and collect behavior information pertaining to the interactions, communications, transactions, events, or operations of the monitored and measurable components that are associated with the activities of the mobile computing device 102. Such activities include a software application's use of a hardware component, performance of an operation or task, a software application's execution in a processing core of the mobile computing device 102, the execution of process, the performance of a task or operation, a device behavior, etc.

The behavior observer module 202 may collect behavior information pertaining to the monitored activities, conditions, operations, or events, and store the collected information in a memory (e.g., in a log file, etc.). The behavior observer module 202 may then communicate (e.g., via a memory write operation, function call, etc.) the collected behavior information to the behavior extractor module 204. The behavior extractor module 204 may be configured to receive or retrieve the collected behavior information, and use this information to generate one or more behavior vectors.

In the various embodiments, the behavior extractor module 204 may be configured to generate the behavior vectors to include a concise definition of the observed behaviors, relationships, or interactions of the software applications. For example, each behavior vector may succinctly describe the collective behavior of the software applications in a value or vector data-structure. The vector data-structure may include series of numbers, each of which signifies a feature or a behavior of the device, such as whether a camera of the computing device is in use (e.g., as zero or one), how much network traffic has been transmitted from or generated by the computing device (e.g., 20 KB/sec, etc.), how many internet messages have been communicated (e.g., number of SMS messages, etc.), and/or any other behavior information collected by the behavior observer module 202. In an embodiment, the behavior extractor module 204 may be configured to generate the behavior vectors so that they function as an identifier that enables the computing device system (e.g., the behavior analyzer module 208) to quickly recognize, identify, or analyze the relationships between applications.

The behavior analyzer module 208 may also be configured to apply the behavior vectors to classifier modules to determine whether a device behavior (i.e., the collective activities of two or more software applications operating on the device) is a non-benign behavior that is contributing to (or is likely to contribute to) the device's degradation over time and/or which may otherwise cause problems on the device. The behavior analyzer module 208 may notify the actuator module 210 that an activity or behavior is not benign. In response, the actuator module 210 may perform various actions or operations to heal, cure, isolate, or otherwise fix identified problems. For example, the actuator module 210 may be configured to stop or terminate one or more of the software applications when the result of applying the behavior vector to the classifier model (e.g., by the analyzer module) indicates that the collective behavior of the software applications not benign.

In various embodiments, the behavior observer module 202 may be configured to monitor the activities of the mobile computing device 102 by collecting information pertaining to library application programming interface (API) calls in an application framework or run-time libraries, system call APIs, file-system and networking sub-system operations, device (including sensor devices) state changes, and other similar events. In addition, the behavior observer module 202 may monitor file system activity, which may include searching for filenames, categories of file accesses (personal info or normal data files), creating or deleting files (e.g., type exe, zip, etc.), file read/write/seek operations, changing file permissions, etc.

The behavior observer module 202 may also monitor the activities of the mobile computing device 102 by monitoring data network activity, which may include types of connections, protocols, port numbers, server/client that the device is connected to, the number of connections, volume or frequency of communications, etc. The behavior observer module 202 may monitor phone network activity, which may include monitoring the type and number of calls or messages (e.g., SMS, etc.) sent out, received, or intercepted (e.g., the number of premium calls placed).

The behavior observer module 202 may also monitor the activities of the mobile computing device 102 by monitoring the system resource usage, which may include monitoring the number of forks, memory access operations, number of files open, etc. The behavior observer module 202 may monitor the state of the mobile computing device 102, which may include monitoring various factors, such as whether the display is on or off, whether the device is locked or unlocked, the amount of battery remaining, the state of the camera, etc. The behavior observer module 202 may also monitor inter-process communications (IPC) by, for example, monitoring intents to crucial services (browser, contracts provider, etc.), the degree of inter-process communications, pop-up windows, etc.

The behavior observer module 202 may also monitor the activities of the mobile computing device 102 by monitoring driver statistics and/or the status of one or more hardware components, which may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the mobile computing device 102.

The behavior observer module 202 may also monitor the activities of the mobile computing device 102 by monitoring one or more hardware counters that denote the state or status of the mobile computing device 102 and/or computing device sub-systems. A hardware counter may include a special-purpose register of the processors/cores that is configured to store a count value or state of hardware-related activities or events occurring in the mobile computing device 102.

The behavior observer module 202 may also monitor the activities of the mobile computing device 102 by monitoring the actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth, WiFi, etc.), content of text-based communications, content of recorded audio files, phonebook or contact information, contacts lists, etc.

The behavior observer module 202 may also monitor the activities of the mobile computing device 102 by monitoring transmissions or communications of the mobile computing device 102, including communications that include voicemail (VoiceMailComm), device identifiers (DeviceIDComm), user account information (UserAccountComm), calendar information (CalendarComm), location information (LocationComm), recorded audio information (RecordAudioComm), accelerometer information (AccelerometerComm), etc.

The behavior observer module 202 may also monitor the activities of the mobile computing device 102 by monitoring the usage of, and updates/changes to, compass information, computing device settings, battery life, gyroscope information, pressure sensors, magnet sensors, screen activity, etc. The behavior observer module 202 may monitor notifications communicated to and from a software application (AppNotifications), application updates, etc. The behavior observer module 202 may monitor conditions or events pertaining to a first software application requesting the downloading and/or install of a second software application. The behavior observer module 202 may monitor conditions or events pertaining to user verification, such as the entry of a password, etc.

The behavior observer module 202 may also monitor the activities of the mobile computing device 102 by monitoring conditions or events at multiple levels of the mobile computing device 102, including the application level, radio level, and sensor level. Application level observations may include observing the user via facial recognition software, observing social streams, observing notes entered by the user, observing events pertaining to the use of PassBook®, Google® Wallet, Paypal®, and other similar applications or services. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc.

Radio level observations may include determining the presence, existence or amount of any or more of user interaction with the mobile computing device 102 before establishing radio communication links or transmitting information, dual/multiple subscriber identification module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

Sensor level observations may include monitoring a magnet sensor or other sensor to determine the usage and/or external environment of the mobile computing device 102. For example, the computing device processor may be configured to determine whether the device is in a holster (e.g., via a magnet sensor configured to sense a magnet within the holster) or in the user's pocket (e.g., via the amount of light detected by a camera or light sensor). Detecting that the mobile computing device 102 is in a holster may be relevant to recognizing suspicious behaviors, for example, because activities and functions related to active usage by a user (e.g., taking photographs or videos, sending messages, conducting a voice call, recording sounds, etc.) occurring while the mobile computing device 102 is holstered could be signs of nefarious processes executing on the device (e.g., to track or spy on the user).

Other examples of sensor level observations related to usage or external environments may include, detecting near field communication (NFC) signaling, collecting information from a credit card scanner, barcode scanner, or mobile tag reader, detecting the presence of a Universal Serial Bus (USB) power charging source, detecting that a keyboard or auxiliary device has been coupled to the mobile computing device 102, detecting that the mobile computing device 102 has been coupled to another computing device (e.g., via USB, etc.), determining whether an LED, flash, flashlight, or light source has been modified or disabled (e.g., maliciously disabling an emergency signaling app, etc.), detecting that a speaker or microphone has been turned on or powered, detecting a charging or power event, detecting that the mobile computing device 102 is being used as a game controller, etc. Sensor level observations may also include collecting information from medical or healthcare sensors or from scanning the user's body, collecting information from an external sensor plugged into the USB/audio jack, collecting information from a tactile or haptic sensor (e.g., via a vibrator interface, etc.), collecting information pertaining to the thermal state of the mobile computing device 102, etc.

To reduce the number of factors monitored to a manageable level, in an embodiment, the behavior observer module 202 may be configured to perform coarse observations by monitoring/observing an initial set of behaviors or factors that are a small subset of all factors that could contribute to the computing device's degradation. In an embodiment, the behavior observer module 202 may receive the initial set of behaviors and/or factors from a server and/or a component in a cloud service or network. In an embodiment, the initial set of behaviors/factors may be specified in machine learning classifier models.

Each classifier model may be a behavior model that includes data and/or information structures (e.g., feature vectors, behavior vectors, component lists, etc.) that may be used by a computing device processor to evaluate a specific feature or embodiment of a computing device's behavior. Each classifier model may also include decision criteria for monitoring a number of features, factors, data points, entries, APIs, states, conditions, behaviors, applications, processes, operations, components, etc. (herein collectively “features”) in the computing device. The classifier models may be preinstalled on the computing device, downloaded or received from a network server, generated in the computing device, or any combination thereof. The classifier models may be generated by using crowd sourcing solutions, behavior modeling techniques, machine learning algorithms, etc.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes/tests only the features/entries that are most relevant for determining whether a particular activity is an ongoing critical activity and/or whether a particular computing device behavior is not benign. As an example, a device processor may be may be configured to receive a full classifier model from a network server, generate a lean classifier model in the computing device based on the full classifier, and use the locally generated lean classifier model to classify a behavior of the device as being either benign or non-benign (i.e., malicious, performance degrading, etc.).

A locally generated lean classifier model is a lean classifier model that is generated in the computing device. That is, since modern computing devices (e.g., mobile devices, etc.) are highly configurable and complex systems, the features that are most important for determining whether a particular device behavior is non-benign (e.g., malicious or performance-degrading) may be different in each device. Further, a different combination of features may require monitoring and/or analysis in each device in order for that device to quickly and efficiently determine whether a particular behavior is non-benign. Yet, the precise combination of features that require monitoring and analysis, and the relative priority or importance of each feature or feature combination, can often only be determined using information obtained from the specific device in which the behavior is to be monitored or analyzed. For these and other reasons, various embodiments may generate classifier models in the computing device in which the models are used. These local classifier models allow the device processor to accurately identify the specific features that are most important in determining whether a behavior on that specific device is non-benign (e.g., contributing to that device's degradation in performance). The local classifier models also allow the device processor to prioritize the features that are tested or evaluated in accordance with their relative importance to classifying a behavior in that specific device.

A device-specific classifier model is a classifier model that includes a focused data model that includes/tests only computing device-specific features/entries that are determined to be most relevant to classifying an activity or behavior in a specific computing device. An application-specific classifier model is a classifier model that includes a focused data model that includes/tests only the features/entries that are most relevant for evaluating a particular software application. By dynamically generating application-specific classifier models locally in the computing device, the various embodiments allow the device processor to focus its monitoring and analysis operations on a small number of features that are most important for determining whether the operations of a specific software application are contributing to an undesirable or performance degrading behavior of that device.

A multi-application classifier model may be a local classifier model that includes a focused data model that includes or prioritizes tests on the features/entries that are most relevant for determining whether the collective behavior of two or more specific software applications (or specific types of software applications) is non-benign. A multi-application classifier model may include an aggregated feature set and/or decision nodes that test/evaluate an aggregated set of features. The device processor may be configured to generate a multi-application classifier model by identifying the device features that are most relevant for identifying the relationships, interactions, and/or communications between two or more software applications operating on the computing device, identifying the test conditions that evaluate one of identified device features, determining the priority, importance, or success rates of the identified test conditions, prioritizing or ordering the identified test conditions in accordance with their importance or success rates, and generating the classifier model to include the identified test conditions so that they are ordered in accordance with their determined priorities, importance, or success rates. The device processor may also be configured to generate a multi-application classifier model by combining two or more application-specific classifier models.

In various embodiments, the device processor may be configured to generate a multi-application classifier model in response to determine that two or more applications are colluding or working in concert or that applications should be analyzed together as a group. The device processor may be configured to generate a multi-application classifier model for each identified group or class of applications. However, analyzing every group may consume a significant amount of the device's limited resources. Therefore, in an embodiment, the device processor may be configured to determine the probability that an application is engaged in a collusive behavior (e.g., based on its interactions with the other applications, etc.), and intelligently generate the classifier models for only the groups that include software applications for which there is a high probability of collusive behavior.

The behavior analyzer module 208 may be configured to apply the behavior vectors generated by the behavior extractor module 204 to a classifier model to determine whether a monitored activity (or behavior) is benign or non-benign. In an embodiment, the behavior analyzer module 208 may classify a behavior as “suspicious” when the results of its behavioral analysis operations do not provide sufficient information to classify the behavior as either benign or non-benign.

The behavior analyzer module 208 may be configured to notify the behavior observer module 202 in response to identifying the colluding software applications, determining that certain applications should be evaluated as a group, and/or in response to determining that a monitored activity or behavior is suspicious. In response, the behavior observer module 202 may adjust the granularity of its observations (i.e., the level of detail at which computing device features are monitored) and/or change the applications/factors/behaviors that are monitored based on information received from the behavior analyzer module 208 (e.g., results of the real-time analysis operations), generate or collect new or additional behavior information, and send the new/additional information to the behavior analyzer module 208 for further analysis/classification.

Such feedback communications between the behavior observer module 202 and the behavior analyzer module 208 enable the mobile computing device 102 to recursively increase the granularity of the observations (i.e., make finer or more detailed observations) or change the features/behaviors that are observed until a collective behavior is classified as benign or non-benign, a source of a suspicious or performance-degrading behavior is identified, until a processing or battery consumption threshold is reached, or until the device processor determines that the source of the suspicious or performance-degrading device behavior cannot be identified from further changes, adjustments, or increases in observation granularity. Such feedback communication also enable the mobile computing device 102 to adjust or modify the behavior vectors and classifier models without consuming an excessive amount of the computing device's processing, memory, or energy resources.

The behavior observer module 202 and the behavior analyzer module 208 may provide, either individually or collectively, real-time behavior analysis of the computing system's behaviors to identify suspicious behavior from limited and coarse observations, to dynamically determine behaviors to observe in greater detail, and to dynamically determine the level of detail required for the observations. This allows the mobile computing device 102 to efficiently identify and prevent problems without requiring a large amount of processor, memory, or battery resources on the device.

In various embodiments, the device processor of the mobile computing device 102 may be configured to identify a critical data resource that requires close monitoring, monitor (e.g., via the behavior observer module 202) API calls made by software applications when accessing the critical data resource, identify a pattern of API calls as being indicative of non-benign behavior by two or more software applications, generate a behavior vector based on the identified pattern of API calls and resource usage, use the behavior vector to perform behavior analysis operations (e.g., via the behavior analyzer module 208), and determine whether one or more of the software application is non-benign based on the behavior analysis operations.

In an embodiment, the device processor may be configured to identify APIs that are used most frequently by software applications operating on the computing device, store information regarding usage of identified hot APIs in an API log in a memory of the device, and perform behavior analysis operations based on the information stored in the API log to identify a non-benign behavior.

In the various embodiments, the mobile computing device 102 may be configured to work in conjunction with a network server to intelligently and efficiently identify the features, factors, and data points that are most relevant to determining whether an activity or behavior is non-benign. For example, the device processor may be configured to receive a full classifier model from the network server, and use the received full classifier model to generate lean classifier models (i.e., data/behavior models) that are specific for the features and functionalities of the computing device or the software applications operating on the device. The device processor may use the full classifier model to generate a family of lean classifier models of varying levels of complexity (or “leanness”). The leanest family of lean classifier models (i.e., the lean classifier model based on the fewest number of test conditions) may be applied routinely until a behavior is encountered that the model cannot categorize as either benign or not benign (and therefore is categorized by the model as suspicious), at which time a more robust (i.e., less lean) lean classifier model may be applied in an attempt to categorize the behavior. The application of ever more robust lean classifier models within the family of generated lean classifier models may be applied until a definitive classification of the behavior is achieved. In this manner, the device processor can strike a balance between efficiency and accuracy by limiting the use of the most complete, but resource-intensive lean classifier models to those situations where a robust classifier model is needed to definitively classify a behavior.

In various embodiments, the device processor may be configured to generate lean classifier models by converting a finite state machine representation/expression included in a full classifier model into boosted decision stumps. The device processor may prune or cull the full set of boosted decision stumps based on device-specific features, conditions, or configurations to generate a classifier model that includes a subset of boosted decision stumps included in the full classifier model. The device processor may then use the lean classifier model to intelligently monitor, analyze and/or classify a computing device behavior.

Boosted decision stumps are one level decision trees that have exactly one node (and thus one test question or test condition) and a weight value, and thus are well suited for use in a binary classification of data/behaviors. That is, applying a behavior vector to boosted decision stump results in a binary answer (e.g., Yes or No). For example, if the question/condition tested by a boosted decision stump is “is the frequency of Short Message Service (SMS) transmissions less than x per minute,” applying a value of “3” to the boosted decision stump will result in either a “yes” answer (for “less than 3” SMS transmissions) or a “no” answer (for “3 or more” SMS transmissions).

Boosted decision stumps are efficient because they are very simple and primal (and thus do not require significant processing resources). Boosted decision stumps are also very parallelizable, and thus many stumps may be applied or tested in parallel/at the same time (e.g., by multiple cores or processors in the computing device).

In an embodiment, the device processor may be configured to generate a lean classifier model that includes a subset of classifier criteria included in the full classifier model and only those classifier criteria corresponding to the features relevant to the computing device configuration, functionality, and connected/included hardware. The device processor may use this lean classifier model(s) to monitor only those features and functions present or relevant to the device. The device processor may then periodically modify or regenerate the lean classifier model(s) to include or remove various features and corresponding classifier criteria based on the computing device's current state and configuration.

As an example, the device processor may be configured to receive a large boosted-decision-stumps classifier model that includes decision stumps associated with a full feature set of behavior models (e.g., classifiers), and derive one or more lean classifier models from the large classifier models by selecting only features from the large classifier model(s) that are relevant the computing device's current configuration, functionality, operating state and/or connected/included hardware, and including in the lean classifier model a subset of boosted decision stumps that correspond to the selected features. In this embodiment, the classifier criteria corresponding to features relevant to the computing device may be those boosted decision stumps included in the large classifier model that test at least one of the selected features. The device processor may then periodically modify or regenerate the boosted decision stumps lean classifier model(s) to include or remove various features based on the computing device's current state and configuration so that the lean classifier model continues to include application-specific or device-specific feature boosted decision stumps.

In addition, the device processor may also dynamically generate application-specific classifier models that identify conditions or features that are relevant to specific software applications (Google® wallet and eTrade®) and/or to a specific type of software application (e.g., games, navigation, financial, news, productivity, etc.). These classifier models may be generated to include a reduced and more focused subset of the decision nodes that are included in the full classifier model (or of those included in a leaner classifier model generated from the received full classifier model). These classifier models may be combined to generate multi-application classifier models.

In various embodiments, the device processor may be configured to generate application-based classifier models for each software application in the system and/or for each type of software application in the system. The device processor may also be configured to dynamically identify the software applications and/or application types that are a high risk or susceptible to abuse (e.g., financial applications, point-of-sale applications, biometric sensor applications, etc.), and generate application-based classifier models for only the software applications and/or application types that are identified as being high risk or susceptible to abuse. In various embodiments, device processor may be configured to generate the application-based classifier models dynamically, reactively, proactively, and/or every time a new application is installed or updated.

Each software application generally performs a number of tasks or activities on the computing device. The specific execution state in which certain tasks/activities are performed in the computing device may be a strong indicator of whether a behavior or activity merits additional or closer scrutiny, monitoring and/or analysis. As such, in the various embodiments, the device processor may be configured to use information identifying the actual execution states in which certain tasks/activities are performed to focus its behavioral monitoring and analysis operations, and better determine whether an activity is a critical activity and/or whether the activity is non-benign.

In various embodiments, the device processor may be configured to associate the activities/tasks performed by a software application with the execution states in which those activities/tasks were performed. For example, the device processor may be configured to generate a behavior vector that includes the behavior information collected from monitoring the instrumented components in a sub-vector or data-structure that lists the features, activities, or operations of the software for which the execution state is relevant (e.g., location access, SMS read operations, sensor access, etc.). In an embodiment, this sub-vector/data-structure may be stored in association with a shadow feature value sub-vector/data-structure that identifies the execution state in which each feature/activity/operation was observed. As an example, the device processor may generate a behavior vector that includes a “location background” data field whose value identifies the number or rate that the software application accessed location information when it was operating in a background state. This allows the device processor to analyze this execution state information independent of and/or in parallel with the other observed/monitored activities of the computing device. Generating the behavior vector in this manner also allows the system to aggregate information (e.g., frequency or rate) over time.

In various embodiments, the device processor may be configured to generate the behavior vectors to include information that may be input to a decision node in the machine learning classifier to generate an answer to a query regarding the monitored activity.

In various embodiments, the device processor may be configured to generate the behavior vectors to include execution information. The execution information may be included in the behavior vector as part of a behavior (e.g., camera used 5 times in 3 second by a background process, camera used 3 times in 3 second by a foreground process, etc.) or as part of an independent feature. In an embodiment, the execution state information may be included in the behavior vector as a shadow feature value sub-vector or data structure. In an embodiment, the behavior vector may store the shadow feature value sub-vector/data structure in association with the features, activities, tasks for which the execution state is relevant.

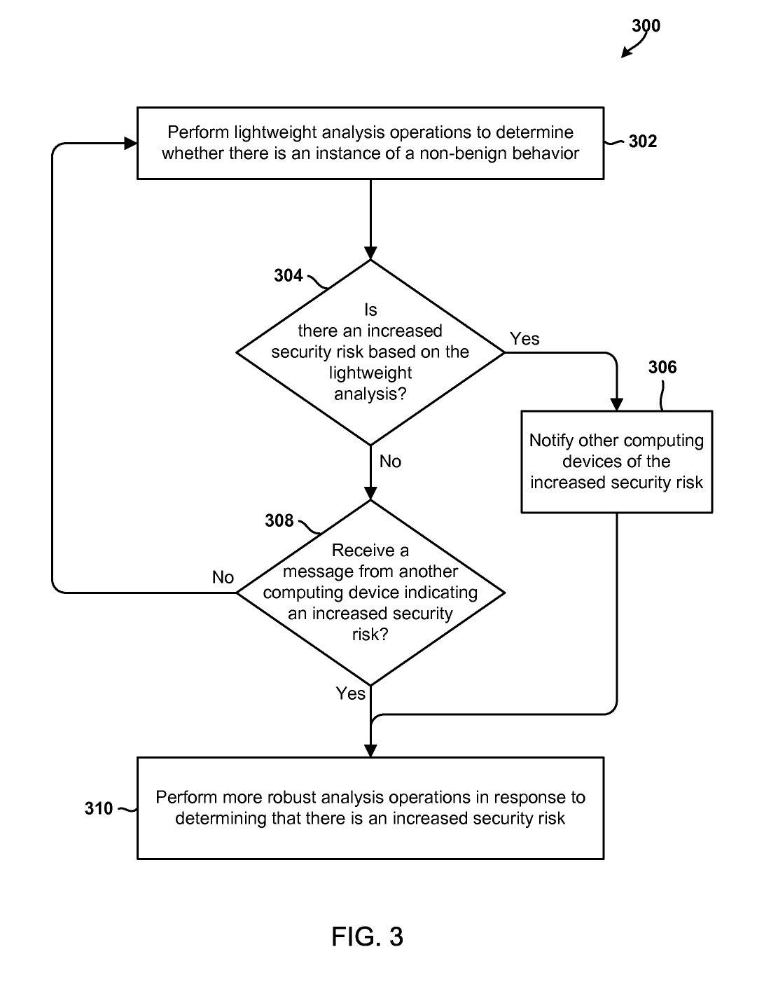

FIG. 3 illustrates a method 300 of method of analyzing behaviors in a computing device in accordance with an embodiment. In block 302, a hardware module or a processor of the computing device may perform lightweight analysis operations to determine whether there is an instance of a non-benign behavior. In determination block 304, the hardware module or processor may determine whether there is an increased security risk based on the results of performing the lightweight analysis operations in block 302. In response to determining that an increased security risk is not present based on the lightweight analysis operations (i.e., determination block 304=“No”), the hardware module or processor may determine whether a message has been received from another computing device indicating that an increased security risk exists in determination block 308. In response to determining that no such message has been received (i.e., determination blocks 304 and 308=“No”), the hardware module or processor may continue performing lightweight analysis operations in block 302.

In response to determining that an increased security risk is present based on the lightweight analysis operations (i.e., determination block 304=“Yes”), such as in response to detecting non-benign behavior, the hardware module or processor may send messages to other computing devices notifying them of the increase security risk in block 306, and perform more robust analysis operations in block 310. The computing device may also perform more robust analysis operations in block 310 in response to receiving a message from another computing device indicating that an increased security risk exists (i.e., determination block 308=“Yes”). Performing more robust analysis operations in block 310 may include running a heavyweight or computationally-intensive scanning engine or process, using a signature-based detection technique, collecting more detailed behavior information in the device, using a more robust classifier model to perform heightened analysis operations, etc.

In an embodiment, while performing more robust analysis operations in block 310 the hardware module or processor may monitor the time since another instance of non-benign behavior is identified (or any non-benign behavior is identified when more robust analysis was initiated in response to a message from another computing device). If no further (or no) instance of non-benign behavior is observed within a defined amount of time, the hardware module or processor may revert to a normal level of scrutiny to conserve processing resources. The defined period of time after which the processor may return to performing lightweight analysis operations may be a predefined time period or a dynamically determined time period. A predefined time period may be defined by a device manufacturer, a service provider (e.g., part of device provisioning information), or a security service (e.g., communicated to the computing device by a server of a security service). A dynamically determined time period may be determined by a processor of the computing device based on information available to the computing device. For example, the time period may be increased or decreased based upon the nature of the detected or number of non-benign behaviors. Thus, if the hardware module or processor detects a non-benign behavior that has relatively severe impact on the computing device or indicates a security vulnerability, the hardware module or processor may dynamically increase the defined period of time that more robust analysis operations will be performed. Similarly, if several non-benign behaviors are identified, the processor may dynamically increase the defined period of time that more robust analysis operations will be performed. On the other hand, if the identified non-benign behavior is of a minor nature or unlikely to render the computing device vulnerable to attack, the hardware module or processor may dynamically decrease the defined period of time that more robust analysis operations will be performed. When robust analysis operations are performed in block 310 in response to receiving a message from another computing device (i.e., determination block 308=“Yes”), the hardware module or processor may dynamically determine the time period that more robust analysis operations will be performed based on a distance between the computing device and a second computing device. Thus, as part of the operations in block 310 may include dynamically determining the defined period of time that more robust analysis operations will be performed based on the nature of the security risk, the number of non-benign behavior instances identified, the nature or severity of the identified non-benign behaviors and/or a distance between the computing device and a second computing device.

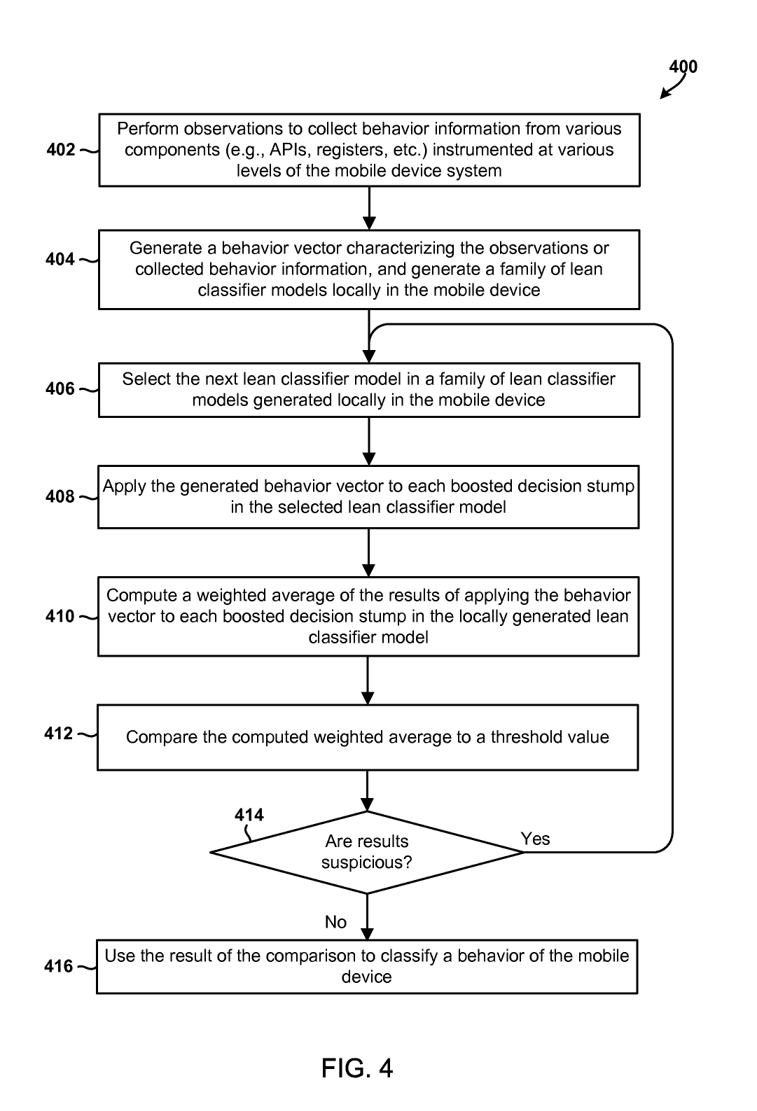

FIG. 4 illustrates an embodiment method 400 of using a lean classifier model to classify a behavior of the computing device. In various embodiments, method 400 may be performed as part of the lightweight analysis operations or as part of the robust analysis operations. In block 402, a processor or processing core of the computing device my perform observations to collect behavior information from various components that are instrumented at various levels of the device system. In an embodiment, this may be accomplished via the behavior observer module 202 discussed above with reference to FIG. 2. In block 404, the processing core may generate a behavior vector characterizing the observations, the collected behavior information, and/or a mobile device behavior. Also in block 404, the processing core may use a full classifier model received from a network server to generate a lean classifier model or a family of lean classifier models of varying levels of complexity (or “leanness”). In an embodiment, the processing core may accomplish this by culling a family of boosted decision stumps included in the full classifier model to generate lean classifier models that include a reduced number of boosted decision stumps and/or evaluate a limited number of test conditions.

In block 406, the processing core may select the leanest classifier in the family of lean classifier models (i.e., the model based on the fewest number of different mobile device states, features, behaviors, or conditions) that has not yet been evaluated or applied by the mobile device. In an embodiment, this may be accomplished by the processing core selecting the first classifier model in an ordered list of classifier models.

In block 408, the processing core may apply collected behavior information or behavior vectors to each boosted decision stump in the selected lean classifier model. Because boosted decision stumps are binary decisions and the lean classifier model is generated by selecting many binary decisions that are based on the same test condition, the process of applying a behavior vector to the boosted decision stumps in the lean classifier model may be performed in a parallel operation. Alternatively, the behavior vector may be truncated or filtered to just include the limited number of test condition parameters included in the lean classifier model, thereby further reducing the computational effort in applying the model.

In block 410, the processing core may compute or determine a weighted average of the results of applying the collected behavior information to each boosted decision stump in the lean classifier model. In block 412, the processing core may compare the computed weighted average to a threshold value. In determination block 414, the processing core may determine whether the results of this comparison and/or the results generated by applying the selected lean classifier model are suspicious. For example, the processing core may determine whether these results may be used to classify a behavior as either malicious or benign with a high degree of confidence, and if not treat the behavior as suspicious.

If the processing core determines that the results are suspicious (e.g., determination block 414=“Yes”), the processing core may repeat the operations in blocks 406-412 to select and apply a stronger (i.e., less lean) classifier model that evaluates more device states, features, behaviors, or conditions until the behavior is classified as malicious or benign with a high degree of confidence. If the processing core determines that the results are not suspicious (e.g., determination block 414=“No”), such as by determining that the behavior can be classified as either malicious or benign with a high degree of confidence, in block 416, the processing core may use the result of the comparison generated in block 412 to classify a behavior of the mobile device as benign or potentially malicious.

In an alternative embodiment method, the operations described above may be accomplished by sequentially selecting a boosted decision stump that is not already in the lean classifier model; identifying all other boosted decision stumps that depend upon the same mobile device state, feature, behavior, or condition as the selected decision stump (and thus can be applied based upon one determination result); including in the lean classifier model the selected and all identified other boosted decision stumps that that depend upon the same mobile device state, feature, behavior, or condition; and repeating the process for a number of times equal to the determined number of test conditions. Because all boosted decision stumps that depend on the same test condition as the selected boosted decision stump are added to the lean classifier model each time, limiting the number of times this process is performed will limit the number of test conditions included in the lean classifier model.

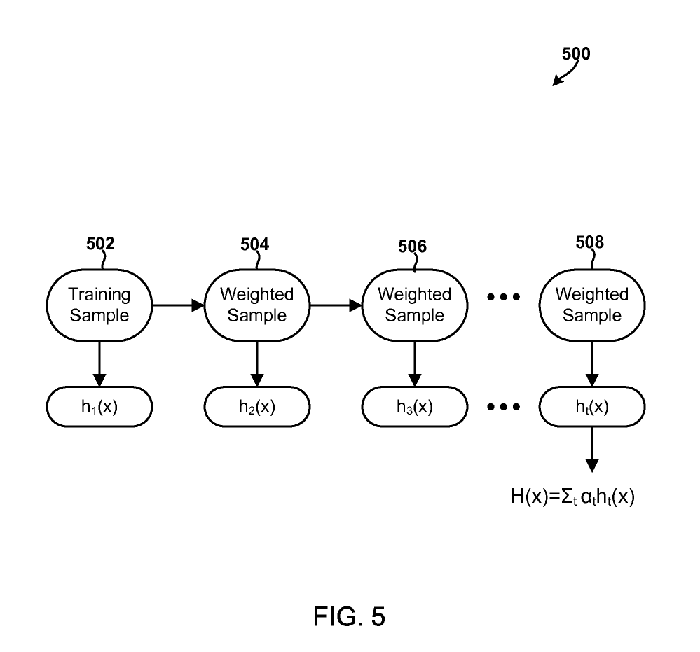

FIG. 5 illustrates an example boosting method 500 suitable for generating a boosted decision tree/classifier that is suitable for use in accordance with various embodiments. In operation 502, a processor may generate and/or execute a decision tree/classifier, collect a training sample from the execution of the decision tree/classifier, and generate a new classifier model (h1(x)) based on the training sample. The training sample may include information collected from previous observations or analysis of mobile device behaviors, software applications, or processes in the mobile device. The training sample and/or new classifier model (h1(x)) may be generated based the types of question or test conditions included in previous classifiers and/or based on accuracy or performance characteristics collected from the execution/application of previous data/behavior models or classifiers of a behavior analyzer module 208. In operation 504, the processor may boost (or increase) the weight of the entries that were misclassified by the generated decision tree/classifier (h1(x)) to generate a second new tree/classifier (h2(x)). In an embodiment, the training sample and/or new classifier model (h2(x)) may be generated based on the mistake rate of a previous execution or use (h1(x)) of a classifier. In an embodiment, the training sample and/or new classifier model (h2(x)) may be generated based on attributes determined to have that contributed to the mistake rate or the misclassification of data points in the previous execution or use of a classifier.

In an embodiment, the misclassified entries may be weighted based on their relatively accuracy or effectiveness. In operation 506, the processor may boost (or increase) the weight of the entries that were misclassified by the generated second tree/classifier (h2(x)) to generate a third new tree/classifier (h3(x)). In operation 508, the operations of 504-506 may be repeated to generate “t” number of new tree/classifiers (hₜ(x)).

By boosting or increasing the weight of the entries that were misclassified by the first decision tree/classifier (h1(x)), the second tree/classifier (h2(x)) may more accurately classify the entities that were misclassified by the first decision tree/classifier (h1(x)), but may also misclassify some of the entities that where correctly classified by the first decision tree/classifier (h1(x)). Similarly, the third tree/classifier (h3(x)) may more accurately classify the entities that were misclassified by the second decision tree/classifier (h2(x)) and misclassify some of the entities that where correctly classified by the second decision tree/classifier (h2(x)). That is, generating the family of tree/classifiers h1(x)-hₜ(x) may not result in a system that converges as a whole, but results in a number of decision trees/classifiers that may be executed in parallel.

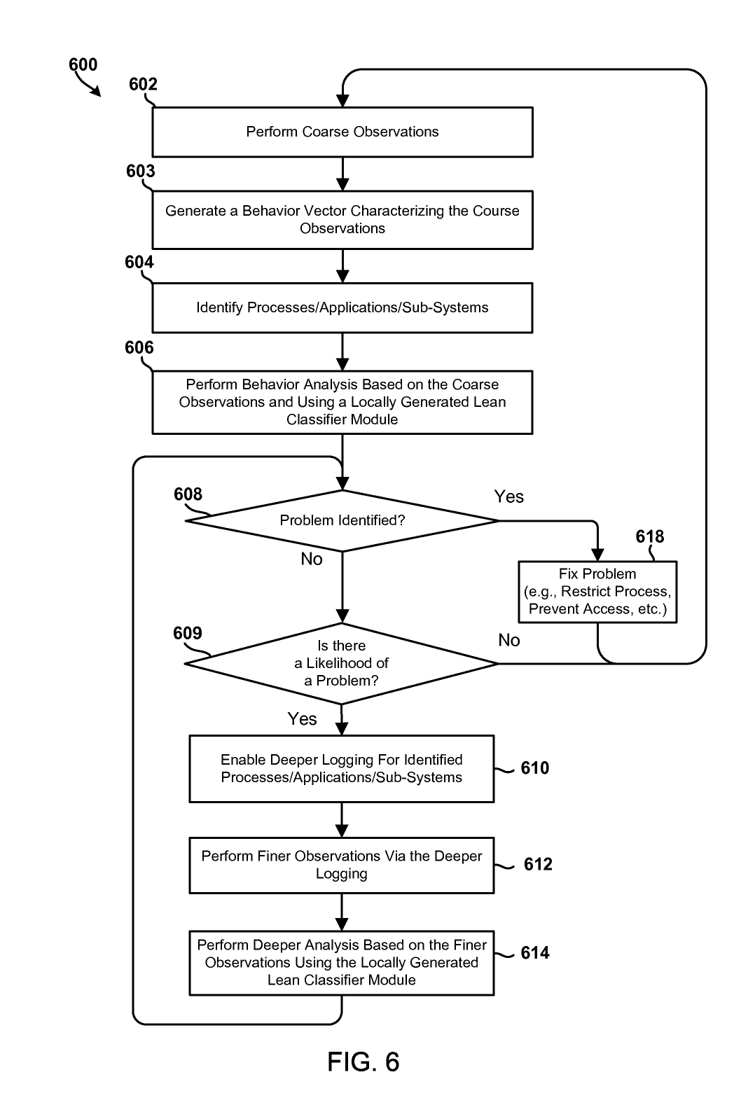

FIG. 6 illustrates an example method 600 for performing dynamic and adaptive observations in accordance with an embodiment. In various embodiments, method 600 may be performed as part of the lightweight analysis operations or as part of the robust analysis operations. In block 602, the mobile device processor (or processing core) may perform coarse observations by monitoring/observing a subset of a large number factors/behaviors that could contribute to the mobile device's degradation. In block 603, the mobile device processor may generate a behavior vector characterizing the coarse observations and/or the mobile device behavior based on the coarse observations. In block 604, the mobile device processor may identify subsystems, processes, and/or applications associated with the coarse observations that may potentially contribute to the mobile device's degradation. This may be achieved, for example, by comparing information received from multiple sources with contextual information received from sensors of the mobile device. In block 606, the mobile device processor may perform behavioral analysis operations based on the coarse observations. In an embodiment, as part of blocks 603 and 604, the mobile device processor may perform one or more of the operations discussed above with reference to FIGS. 2-5.

In determination block 608, the mobile device processor may determine whether suspicious behaviors or potential problems can be identified and corrected based on the results of the behavioral analysis. When the mobile device processor determines that the suspicious behaviors or potential problems can be identified and corrected based on the results of the behavioral analysis (i.e., determination block 608=“Yes”), in block 618, the processor may initiate a process to correct the behavior and return to block 602 to perform additional coarse observations.

When the mobile device processor determines that the suspicious behaviors or potential problems cannot be identified and/or corrected based on the results of the behavioral analysis (i.e., determination block 608=“No”), in determination block 609 the mobile device processor may determine whether there is a likelihood of a problem. In an embodiment, the mobile device processor may determine that there is a likelihood of a problem by computing a probability of the mobile device encountering potential problems and/or engaging in suspicious behaviors, and determining whether the computed probability is greater than a predetermined threshold. When the mobile device processor determines that the computed probability is not greater than the predetermined threshold and/or there is not a likelihood that suspicious behaviors or potential problems exist and/or are detectable (i.e., determination block 609=“No”), the processor may return to block 602 to perform additional coarse observations.

When the mobile device processor determines that there is a likelihood that suspicious behaviors or potential problems exist and/or are detectable (i.e., determination block 609=“Yes”), in block 610, the mobile device processor may perform more robust analysis operations that include performing deeper logging/observations or final logging on the identified subsystems, processes or applications. In block 612, the mobile device processor may perform deeper and more detailed observations on the identified subsystems, processes or applications. In block 614, the mobile device processor may perform further and/or deeper behavioral analysis based on the deeper and more detailed observations. In determination block 608, the mobile device processor may again determine whether the suspicious behaviors or potential problems can be identified and corrected based on the results of the deeper behavioral analysis. When the mobile device processor determines that the suspicious behaviors or potential problems cannot be identified and corrected based on the results of the deeper behavioral analysis (i.e., determination block 608=“No”), the processor may repeat the operations in blocks 610-614 until the level of detail is fine enough to identify the problem or until it is determined that the problem cannot be identified with additional detail or that no problem exists.

When the mobile device processor determines that the suspicious behaviors or potential problems can be identified and corrected based on the results of the deeper behavioral analysis (i.e., determination block 608=“Yes”), in block 618, the mobile device processor may perform operations to correct the problem/behavior, and the processor may return to block 602 to perform additional operations.

In an embodiment, as part of blocks 602-618 of method 600, the mobile device processor may perform real-time behavior analysis of the system's behaviors to identify suspicious behaviors from limited and coarse observations, to dynamically determine the behaviors to observe in greater detail, and to dynamically determine the precise level of detail required for the observations. This enables the mobile device processor to efficiently identify and prevent problems from occurring, without requiring the use of a large amount of processor, memory, or battery resources on the device.

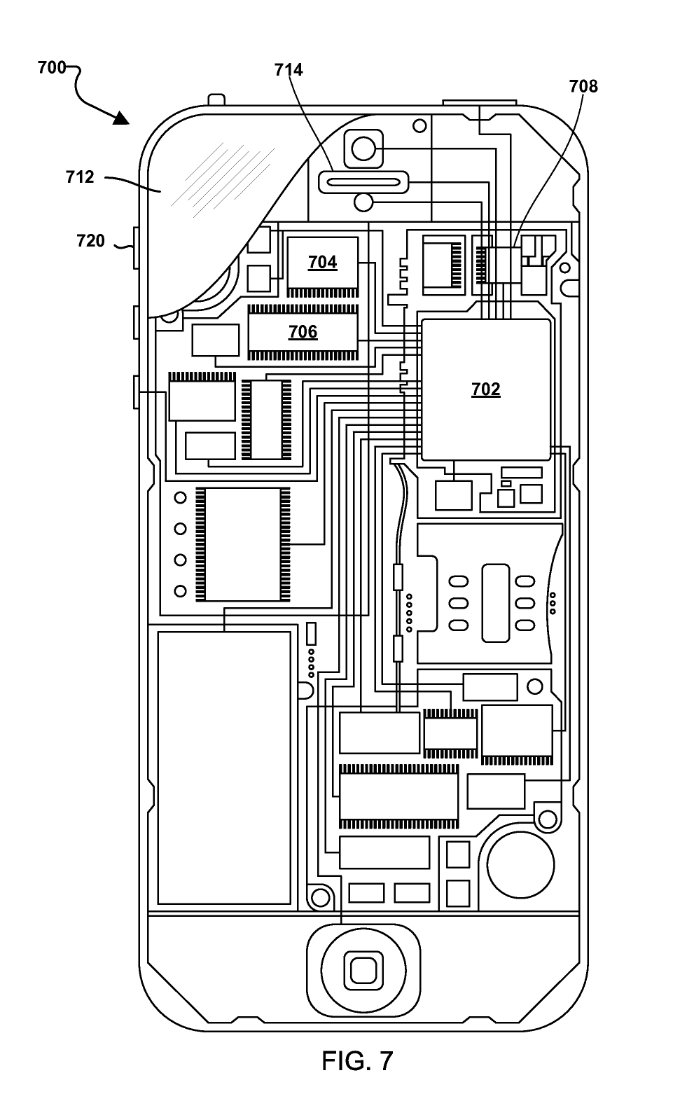

The various embodiments may be implemented on a variety of computing devices, an example of which is illustrated in FIG. 7 in the form of a smartphone. A smartphone 700 may include a processor 702 coupled to internal memory 704, a display 712, and to a speaker 714. Additionally, the smartphone 700 may include an antenna for sending and receiving electromagnetic radiation that may be connected to a wireless data link and/or cellular telephone transceiver 708 coupled to the processor 702. Smartphones 700 typically also include menu selection buttons or rocker switches 720 for receiving user inputs.

A typical smartphone 700 also includes a sound encoding/decoding (CODEC) circuit 706, which digitizes sound received from a microphone into data packets suitable for wireless transmission and decodes received sound data packets to generate analog signals that are provided to the speaker to generate sound. Also, one or more of the processor 702, wireless transceiver 708 and CODEC 706 may include a digital signal processor (DSP) circuit (not shown separately).

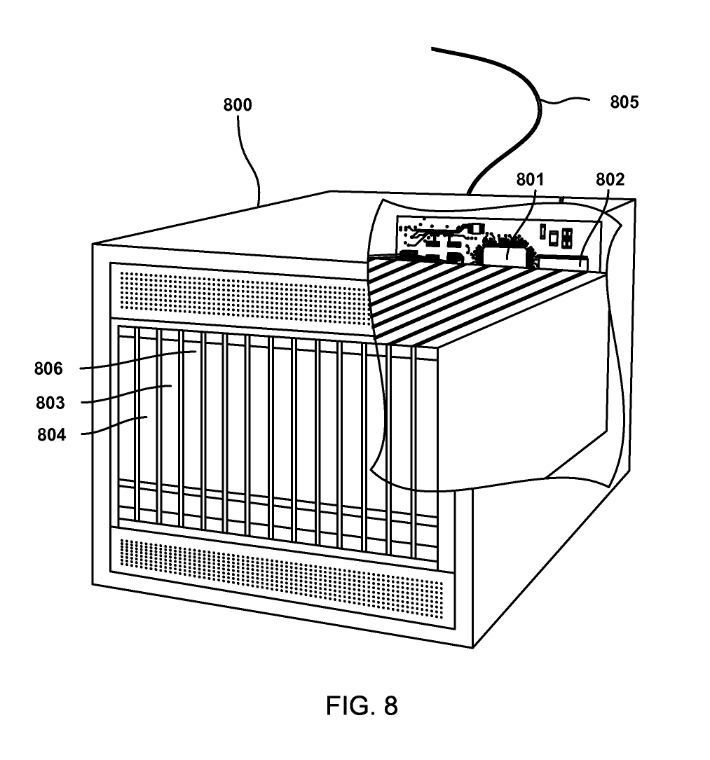

Portions of the embodiment methods may be accomplished in a client-server architecture with some of the processing occurring in a server, such as maintaining databases of normal operational behaviors, which may be accessed by a mobile device processor while executing the embodiment methods. Such embodiments may be implemented on any of a variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing data connections with a network 805, such as a local area network coupled to other broadcast system computers and servers.

The processors 702, 801 may be any programmable microprocessor, microcomputer or multiple processor chip or chips that can be configured by software instructions (applications) to perform a variety of functions, including the functions of the various embodiments described below. In some mobile devices, multiple processors 702 may be provided, such as one processor dedicated to wireless communication functions and one processor dedicated to running other applications. Typically, software applications may be stored in the internal memory 704, 802, 803 before they are accessed and loaded into the processor 702, 801. The processor 702, 801 may include internal memory sufficient to store the application software instructions.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The term “performance degradation” is used in this application to refer to a wide variety of undesirable mobile device operations and characteristics, such as longer processing times, slower real time responsiveness, lower battery life, loss of private data, malicious economic activity (e.g., sending unauthorized premium SMS message), denial of service (DoS), operations relating to commandeering the mobile device or utilizing the phone for spying or botnet activities, etc.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of analyzing behaviors in a computing device, comprising:
performing, in a processor of the computing device, a first type of analysis operations to determine whether there is an increased security risk, the first type of analysis operations including monitoring the computing device for an indication of the increased security risk or a previous occurrence of risk; and
performing a second type of analysis operations in response to determining that there is the increased security risk, wherein the second type of analysis operations are more computationally-intensive than the first type of analysis operations.

2. The method of claim 1, wherein:
performing the first type of analysis operations comprises performing lightweight analysis operations; and
performing the second type of analysis operations comprises performing robust analysis operations.

3. The method of claim 2, wherein performing robust analysis operations comprises identifying another security risk that is different than the increased security risk detected via lightweight analysis operations.

4. The method of claim 2, wherein performing lightweight analysis operations comprises:
monitoring device behaviors to collect behavior information;
generating a behavior vector data structure based on the collected behavior information;
applying the behavior vector data structure to a lean classifier model to obtain a determination of whether a first device behavior is non-benign; and
determining that there is the increased security risk in response to determining that the first device behavior is non-benign.

5. The method of claim 2, wherein performing robust analysis operations comprises performing a full scan of the computing device.

6. The method of claim 2, wherein performing robust analysis operations comprises applying a behavior vector data structure to a full classifier model to obtain a determination of whether another security risk is present in the computing device.

7. The method of claim 2, wherein performing robust analysis operations comprises:
monitoring additional device behaviors to collect additional behavior information;
generating a plurality of behavior vector data structures based on the collected additional behavior information; and
applying each of the plurality of behavior vector data structures to a classifier model.

8. The method of claim 2, wherein performing robust analysis operations in response to determining that there is the increased security risk comprises performing robust analysis operations for a dynamically determined time period.

9. The method of claim 8, further comprising dynamically determining the time period based on a distance between the computing device and a second computing device.

10. The method of claim 1, wherein monitoring the computing device for the indication of the increased security risk or the previous occurrence of risk comprises:
monitoring the computing device for a notification message from another computing device indicating the increased security risk.

11. The method of claim 1, wherein monitoring the computing device for the indication of the increased security risk or the previous occurrence of risk comprises:
monitoring one or more of an internal computation, a file, a functional behavior, and a data access request.

12. The method of claim 1, wherein monitoring the computing device for the indication of the increased security risk or the previous occurrence of risk comprises:
monitoring the computing device to identify a data pattern associated with non-benign actions.

13. The method of claim 1, further comprising:
generating a notification message that includes risk information in response to determining that there is the increased security risk; and
sending the notification message to one or more computing devices.

14. The method of claim 1, wherein monitoring the computing device for the indication of the increased security risk or the previous occurrence of risk comprises:
monitoring the computing device for common consequences of malware infection.

15. The method of claim 14, wherein monitoring the computing device for common consequences of malware infection comprises performing one of:
monitoring a number of premium SMS message sent in a period of time;
monitoring increases in traffic to sites associated with malicious behavior;
monitoring a number of address book contacts communicated in the period of time;
monitoring a number of password modifications in the period of time; and
monitoring changes to device configuration.

16. The method of claim 1, further comprising:
receiving a notification message from another computing device that includes risk information; and
determining that there is the increased security risk based on the risk information included in the received notification message.

17. The method of claim 16, wherein determining that there is the increased security risk based on the risk information included in the received notification message comprises determining that there is the increased security risk based at least in part on a distance between the another computing device sending the received notification message, wherein the distance comprises one or more of a physical distance, a time difference between a detected security risk and the received notification message, a network separation distance, a number of times the computing device has been rebooted, a number of times a software application has been updated, differences between software versions, and make/model/version/feature/hardware differences between the transmitting and receiving computing devices.

18. A computing device, comprising:
means for performing a first type of analysis operations to determine whether there is an increased security risk, the first type of analysis operations including monitoring the computing device for an indication of the increased security risk or a previous occurrence of risk; and
means for performing a second type of analysis operations in response to determining that there is the increased security risk, wherein the second type of analysis operations are more computationally-intensive than the first type of analysis operations.

19. The computing device of claim 18, wherein:
means for performing the first type of analysis operations comprises means for performing lightweight analysis operations; and
means for performing the second type of analysis operations comprises means for performing robust analysis operations.

20. The computing device of claim 19, wherein means for performing robust analysis operations comprises means for identifying another security risk that is different than the increased security risk detected via lightweight analysis operations.

21. A computing device, comprising:
a processor configured with processor-executable software instructions to perform operations comprising:
performing a first type of analysis operations to determine whether there is an increased security risk, the first type of analysis operations including monitoring the computing device for an indication of the increased security risk or a previous occurrence of risk; and
performing a second type of analysis operations in response to determining that there is the increased security risk, wherein the second type of analysis operations are more computationally-intensive than the first type of analysis operations.

22. The computing device of claim 21, wherein the processor is configured with processor-executable software instructions to perform operations further comprising:
receiving a notification message from another computing device that includes risk information; and
determining that there is the increased security risk based on the risk information included in the received notification message and a distance between the computing device and the another computing device sending the received notification message.

23. The computing device of claim 21, wherein the processor is configured with processor-executable software instructions to perform operations such that:
performing the first type of analysis operations comprises performing lightweight analysis operations; and
performing the second type of analysis operations comprises performing robust analysis operations.

24. The computing device of claim 23, wherein the processor is configured with processor-executable software instructions to perform operations such that performing robust analysis operations comprises identifying another security risk that is different than the increased security risk detected via lightweight analysis operations.

25. The computing device of claim 23, wherein the processor is configured with processor-executable software instructions to perform operations such that performing lightweight analysis operations comprises:
monitoring device behaviors to collect behavior information;
generating a behavior vector data structure based on the collected behavior information;
applying the behavior vector data structure to a lean classifier model to obtain a determination of whether a first device behavior is non-benign; and
determining that there is the increased security risk in response to determining that the first device behavior is non-benign.

26. The computing device of claim 23, wherein the processor is configured with processor-executable software instructions to perform operations such that performing robust analysis operations comprises:
monitoring additional device behaviors to collect additional behavior information;
generating a plurality of behavior vector data structures based on the collected additional behavior information; and
applying each of the plurality of behavior vector data structures to a classifier model.

27. A non-transitory computer readable storage medium having stored thereon processor-executable software instructions configured to cause a processor of a computing device to perform operations comprising:
performing a first type of analysis operations to determine whether there is an increased security risk, the first type of analysis operations including monitoring the computing device for an indication of the increased security risk or a previous occurrence of risk; and
performing a second type of analysis operations in response to determining that there is the increased security risk, wherein the second type of analysis operations are more computationally-intensive than the first type of analysis operations.

28. The non-transitory computer readable storage medium of claim 27, wherein the stored processor-executable software instructions are configured to cause a processor to perform operations further comprising:
receiving a notification message from another computing device that includes risk information; and
determining that there is the increased security risk based on the risk information included in the received notification message and a distance to the another computing device sending the received notification message.

29. The non-transitory computer readable storage medium of claim 27, wherein the stored processor-executable software instructions are configured to cause a processor to perform operations such that:
performing the first type of analysis operations comprises performing lightweight analysis operations; and
performing the second type of analysis operations comprises performing robust analysis operations.

30. The non-transitory computer readable storage medium of claim 29, wherein the stored processor-executable software instructions are configured to cause a processor to perform operations such that performing robust analysis operations comprises identifying another security risk that is different than the increased security risk detected via lightweight analysis operations.
